(19) United States
(12) Patent Application Publication
(10) Pub. No.: US 2019/0159228 A1
(43) Pub. Date: May 23, 2019

(54) INFORMATION TRANSMITTING METHOD FOR TRANSMITTING BEAM-RELATED UPLINK CONTROL INFORMATION IN WIRELESS COMMUNICATION SYSTEM

(71) Applicant: LG ELECTRONICS INC., Seoul (KR)

(72) Inventors: Kilbom LEE, Seoul (KR); Jaehoon CHUNG, Seoul (KR); Kyuseok KIM, Seoul (KR); Ilmu BYUN, Seoul (KR); Minki AHN, Seoul (KR)

(73) Assignee: LG ELECTRONICS INC., Seoul (KR)

(21) Appl. No.: 16/098,079

(22) PCT Filed: Apr. 27, 2017
(86) PCT No.: PCT/KR2017/004506

§ 371 Date: Oct. 31, 2018

Related U.S. Application Data
(60) Provisional application No. 62/337,892, filed on May 18, 2016.

(51) Int. Cl. H04W 72/12; H04W 72/04; H04W 16/28

(52) U.S. Cl. CPC H04W 72/1268; H04W 16/28; H04W 72/04

(57) ABSTRACT

Disclosed is an information transmitting method and terminal for transmitting beam-related uplink information, wherein the terminal can determine whether a beam mismatch from a base station has occurred, and transmit beam-related information including the beam mismatch to the base station, so as to solve a beam mismatch.

### TECHNICAL FIELD

Following description relates to a wireless communication system. More particularly, when a beam mismatch occurs between a beam preferred by a user equipment and a beam provided by a base station, following description relates to a method for a user equipment to transmit information for transmitting beam-related control information to the base station to solve the beam mismatch problem and an apparatus therefor.

### BACKGROUND ART

An ultrahigh frequency wireless communication system based on mmWave is configured to operate at a center frequency of several GHz to several tens of GHz. Due to the characteristic of the center frequency, a pathloss may considerably occurs in a radio shadow area. In consideration of the pathloss, it is necessary to delicately design beamforming of a signal transmitted to a user equipment in mmWave communication system. Moreover, it is necessary to control and prevent occurrence of a beam mismatch.

### DISCLOSURE OF THE INVENTION

### Technical Tasks

The present invention is designed to solve the abovementioned problem. An object of the present invention is to solve a beam mismatch between a base station and a user equipment in a wireless communication system.

When a beam mismatch occurs between a base station and a user equipment, another object of the present invention is to improve communication efficiency of a procedure for the user equipment to transmit a signal for solving the beam mismatch to the base station.

The other object of the present invention is to simplify a procedure for a base station to transmit a signal for solving a beam mismatch to a user equipment.

The technical problems solved by the present invention are not limited to the above technical problems and other technical problems which are not described herein will become apparent to those skilled in the art from the following description.

### Technical Solution

To achieve these and other advantages and in accordance with the purpose of the present invention, as embodied and broadly described, according to one embodiment, a method of transmitting beam-related uplink control information, which is transmitted by a user equipment (UE) in an mmWave communication system, includes determining occurrence of a beam mismatch from a base station, when the beam mismatch occurs, transmitting an SR (scheduling request) requesting an uplink resource for performing feedback on beam-related control information to the base station via a first resource among a plurality of resources allocated by the base station to transmit the SR, receiving downlink control information containing uplink assignment information for performing feedback on the beam-related control information from the base station, and transmitting uplink control information containing the beam-related control information via an uplink resource allocated by the base station. In this case, a plurality of the resources include the first resource and a second resource in which an SR requesting an uplink resource for transmitting uplink data transmitted by the UE is transmitted and the first resource may be different from the second resource.

In this case, the beam-related control information can include index information of a beam preferred by the UE.

The uplink control information transmitting step can transmit the uplink control information by multiplexing the uplink control information with a transmission region of an uplink data channel.

The uplink assignment information for performing feedback on the beam-related control information can include a beam-related control information feedback request field having a size of 1 bit.

When the SR corresponds to a first SR transmitted to the base station, the UE can transmit the beam-related control information to the base station irrespective of a value of a beam-related control information feedback request field.

When the SR is transmitted after the predetermined number of subframes appearing after an SR recently transmitted to the base station, the UE can transmit the beam-related control information to the base station irrespective of a value of a beam-related control information feedback request field.

A plurality of the resources can further include a third resource in which an SR requesting transmission of a BRRS (beam refinement reference signal) to the base station is transmitted and the third resource may be different from the first resource and the second resource.

In this case, when the beam mismatch occurs and there is no beam preferred by the UE, the method can further include the step of transmitting the SR requesting the transmission of the BRRS to the base station via the second resource among a plurality of the resources.

To further achieve these and other advantages and in accordance with the purpose of the present invention, according to a different embodiment, a user equipment (UE) for transmitting uplink control information in an mmWave communication system includes a transmitter, a receiver, and a processor connected to the transmitter and the receiver to operate. In this case, the processor is configured to determine occurrence of a beam mismatch from a base station, when the beam mismatch occurs, transmit an SR (scheduling request) requesting an uplink resource for performing feedback on beam-related control information via a first resource among a plurality of resources allocated by the base station to transmit the SR, receive downlink control information including uplink assignment information for performing feedback on the beam-related control information from the base station, and transmit uplink control information including the beam-related control information via an uplink resource allocated by the base station. In this case, a plurality of the resources include the first resource and a second resource in which an SR requesting an uplink resource for transmitting uplink data transmitted by the UE is transmitted and the first resource may be different from the second resource.

### Advantageous Effects

According to embodiments of the present invention, the following effects are expected.

First of all, since it is able to solve a beam mismatch between a base station and a user equipment in a wireless communication system, it is able to improve wireless connectivity quality of mmWave communication system.

Second, it is able to reduce signaling overhead for transmitting and receiving information for solving a beam mismatch.

Third, when a base station transmits a signal for solving a beam mismatch to a user equipment, it is able to reduce signaling overhead and save a radio resource.

The effects of the present invention are not limited to the above-described effects and other effects which are not described herein may be derived by those skilled in the art from the following description of the embodiments of the present invention. That is, effects which are not intended by the present invention may be derived by those skilled in the art from the embodiments of the present invention.

### DESCRIPTION OF DRAWINGS

The accompanying drawings, which are included to provide a further understanding of the invention, illustrate embodiments of the invention and together with the description serve to explain the principle of the invention. The technical features of the present invention are not limited to specific drawings and the features shown in the drawings are combined to construct a new embodiment. Reference numerals of the drawings mean structural elements.

FIG. 1 is a diagram illustrating a Doppler spectrum;

FIG. 2 is a diagram illustrating narrow beamforming related to the present invention;

FIG. 3 is a diagram illustrating a Doppler spectrum when narrow beamforming is performed;

FIG. 4 is a diagram showing an example of a synchronization signal service area of a base station;

FIG. 5 shows an example of a frame structure proposed in a communication environment that uses mmWave;

FIG. 6 shows a structure of OVSF (orthogonal variable spreading factor) code.

FIG. 7 is a diagram to describe a disposed situation of user equipments;

FIG. 8 is a diagram illustrating a resource region structure used in a communication system using mmWave;

FIG. 9 is a flowchart illustrating a method of transmitting a signal according to a proposed embodiment;

FIG. 10 is a diagram illustrating a method of configuring a field according to a different proposed embodiment;

FIG. 11 is a diagram illustrating configurations of a user equipment and a base station related to a proposed embodiment.

### BEST MODE

### Mode for Invention

Although the terms used in the present invention are selected from generally known and used terms, terms used herein may be varied depending on operator's intention or customs in the art, appearance of new technology, or the like. In addition, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The following embodiments are proposed by combining constituent components and characteristics of the present invention according to a predetermined format. The individual constituent components or characteristics should be considered optional factors on the condition that there is no additional remark. If required, the individual constituent components or characteristics may not be combined with other components or characteristics. In addition, some constituent components and/or characteristics may be combined to implement the embodiments of the present invention. The order of operations to be disclosed in the embodiments of the present invention may be changed. Some components or characteristics of any embodiment may also be included in other embodiments, or may be replaced with those of the other embodiments as necessary.

In describing the present invention, if it is determined that the detailed description of a related known function or construction renders the scope of the present invention unnecessarily ambiguous, the detailed description thereof will be omitted.

In the entire specification, when a certain portion “comprises or includes” a certain component, this indicates that the other components are not excluded and may be further included unless specially described otherwise. The terms “unit”, “-or/er” and “module” described in the specification indicate a unit for processing at least one function or operation, which may be implemented by hardware, software or a combination thereof. The words “a or an”, “one”, “the” and words related thereto may be used to include both a singular expression and a plural expression unless the context describing the present invention (particularly, the context of the following claims) clearly indicates otherwise.

In this document, the embodiments of the present invention have been described centering on a data transmission and reception relationship between a mobile station and a base station. The base station may mean a terminal node of a network which directly performs communication with a mobile station. In this document, a specific operation described as performed by the base station may be performed by an upper node of the base station.

Namely, it is apparent that, in a network comprised of a plurality of network nodes including a base station, various operations performed for communication with a mobile station may be performed by the base station, or network nodes other than the base station. The term base station may be replaced with the terms fixed station, Node B, eNode B (eNB), advanced base station (ABS), access point, etc.

The term mobile station (MS) may be replaced with user equipment (UE), subscriber station (SS), mobile subscriber station (MSS), mobile terminal, advanced mobile station (AMS), terminal, etc.

A transmitter refers to a fixed and/or mobile node for transmitting a data or voice service and a receiver refers to a fixed and/or mobile node for receiving a data or voice service. Accordingly, in uplink, a mobile station becomes a transmitter and a base station becomes a receiver. Similarly, in downlink transmission, a mobile station becomes a receiver and a base station becomes a transmitter.

Communication of a device with a “cell” may mean that the device transmit and receive a signal to and from a base station of the cell. That is, although a device substantially transmits and receives a signal to a specific base station, for convenience of description, an expression “transmission and reception of a signal to and from a cell formed by the specific base station” may be used. Similarly, the term “macro cell” and/or “small cell” may mean not only specific coverage but also a “macro base station supporting the macro cell” and/or a “small cell base station supporting the small cell”.

The embodiments of the present invention can be supported by the standard documents disclosed in any one of wireless access systems, such as an IEEE 802.xx system, a 3rd Generation Partnership Project (3GPP) system, a 3GPP Long Term Evolution (LTE) system, and a 3GPP2 system. That is, the steps or portions, which are not described in order to make the technical spirit of the present invention clear, may be supported by the above documents.

In addition, all the terms disclosed in the present document may be described by the above standard documents. In particular, the embodiments of the present invention may be supported by at least one of P802.16-2004, P802.16e-2005, P802.16.1, P802.16p and P802.16.1b documents, which are the standard documents of the IEEE 802.16 system.

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment which the present invention can be carried out.

It should be noted that specific terms disclosed in the present invention are proposed for convenience of description and better understanding of the present invention, and the use of these specific terms may be changed to another format within the technical scope or spirit of the present invention.

1. Communication System Using Ultrahigh Frequency Band

In an LTE (Long Term Evolution)/LTE-A (LTE Advanced) system, an error value of oscillators between a UE and an eNB is defined by requirements as follows.
UE side frequency error (in TS 36.101)

The UE modulated carrier frequency shall be accurate to within±0.1 PPM observed over a period of one time slot (0.5 ms) compared to the carrier frequency received from the E-UTRA Node B
eNB side frequency error (in TS 36.104)

Frequency error is the measure of the difference between the actual BS transmit frequency and the assigned frequency.

Meanwhile, oscillator accuracy according to types of BS is as listed in Table 1 below.

TABLE 1

| BS class | Accuracy | |
|---|---|---|
| Wide Area BS | ±0.05 | ppm |
| Local Area BS | ±0.1 | ppm |
| Home BS | ±0.25 | ppm |

Therefore, a maximum difference in oscillators between a BS and a UE is ±0.1 ppm, and when an error occurs in one direction, an offset value of maximum 0.2 ppm may occur. This offset value is converted to a unit of Hz suitable for each center frequency by being multiplied by the center frequency.

Meanwhile, in an OFDM system, a CFO value is varied depending on a subcarrier spacing. Generally, the OFDM system of which subcarrier spacing is sufficiently great is relatively less affected by even a great CFO value. Therefore, an actual CFO value (absolute value) needs to be expressed as a relative value that affects the OFDM system. This will be referred to as normalized CFO. The normalized CFO is expressed as a value obtained by dividing the CFO value by the subcarrier spacing. The following Table 2 illustrates CFO of an error value of each center frequency and oscillator and normalized CFO.

TABLE 2

| Center | | | | | | | | |
|---|---|---|---|---|---|---|---|---|
| frequency | | | | | | | | |
| (subcarrier | Oscillator Offset | | | | | | | |
| spacing) | ±0.05 ppm | | ±0.1 ppm | | ±10 ppm | | ±20 ppm | |
| 2 GHz(15 | ±100 | Hz | ±200 | Hz | ±20 | kHz | ±40 | kHz |
| kHz) | (±0.0067) | | (±0.0133) | | (±1.3) | | (±2.7) | |
| 30 GHz(104.25 | ±1.5 | kHz | ±3 | kHz | ±300 | kHz | ±600 | kHz |
| kHz) | (±0.014) | | (±0.029) | | (±2.9) | | (±5.8) | |
| 60 GHz(104.25 | ±3 | kHz | ±6 | kHz | ±600 | kHz | ±1.2 | MHz |

| | | | | |
|---|---|---|---|---|
| kHz) | (±0.029) | (±0.058) | (±5.8) | (±11.5) |

In Table 2, it is assumed that a subcarrier spacing is 15 kHz when the center frequency is 2 GHz (for example, LTE Rel-8/9/10). When the center frequency is 30 GHz or 60 GHz, a subcarrier spacing of 104.25 kHz is used, whereby throughput degradation is avoided considering Doppler effect for each center frequency. The above Table 2 is a simple example, and it will be apparent that another subcarrier spacing may be used for the center frequency.

Meanwhile, Doppler spread occurs significantly in a state that a UE moves at high speed or moves at a high frequency band. Doppler spread causes spread in a frequency domain, whereby distortion of a received signal is generated in view of the receiver. Doppler spread may be expressed as f_{doppler}=(ν/λ)cosθ. At this time, ν is a moving speed of the UE, and λ means a wavelength of a center frequency of a radio wave which is transmitted. θ means an angle between the radio wave and a moving direction of the UE. Hereinafter, description will be given on the assumption that θ is 0.

At this time, a coherence time is inverse proportion to Doppler spread. If the coherence time is defined as a time spacing of which correlation value of a channel response in a time domain is 50% or more, the coherence time is expressed as

$${T}_{c} \approx \frac{9}{16 π {f}_{doppler}} .$$

In the wireless communication system, the following Equation 1 which indicates a geometric mean between an equation for Doppler spread and an equation for the coherence time is used mainly.

$${T}_{c} = \sqrt{\frac{9}{16 π {f}_{doppler}}} = \frac{0.423}{{f}_{doppler}} \qquad [ Equation 1 ]$$

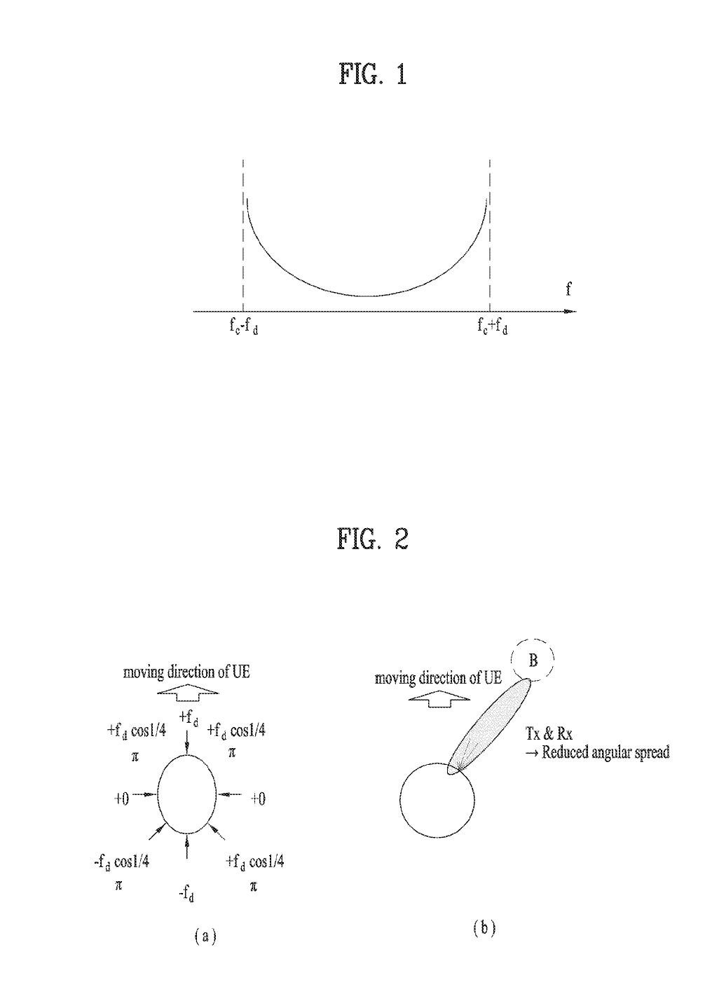

FIG. 1 is a diagram illustrating a Doppler spectrum.

A Doppler spectrum or Doppler power spectrum density, which indicates a change of a Doppler value according to a frequency change, may have various shapes depending on a communication environment. Generally, in an environment, such as downtown area, where scattering occurs frequently, if received signals are received at the same power in all directions, the Doppler spectrum is indicated in the form of U-shape as shown in FIG. 1. FIG. 1 shows a U-shaped Doppler spectrum when the center frequency is f_{c} and a maximum Doppler spread value is f_{d}.

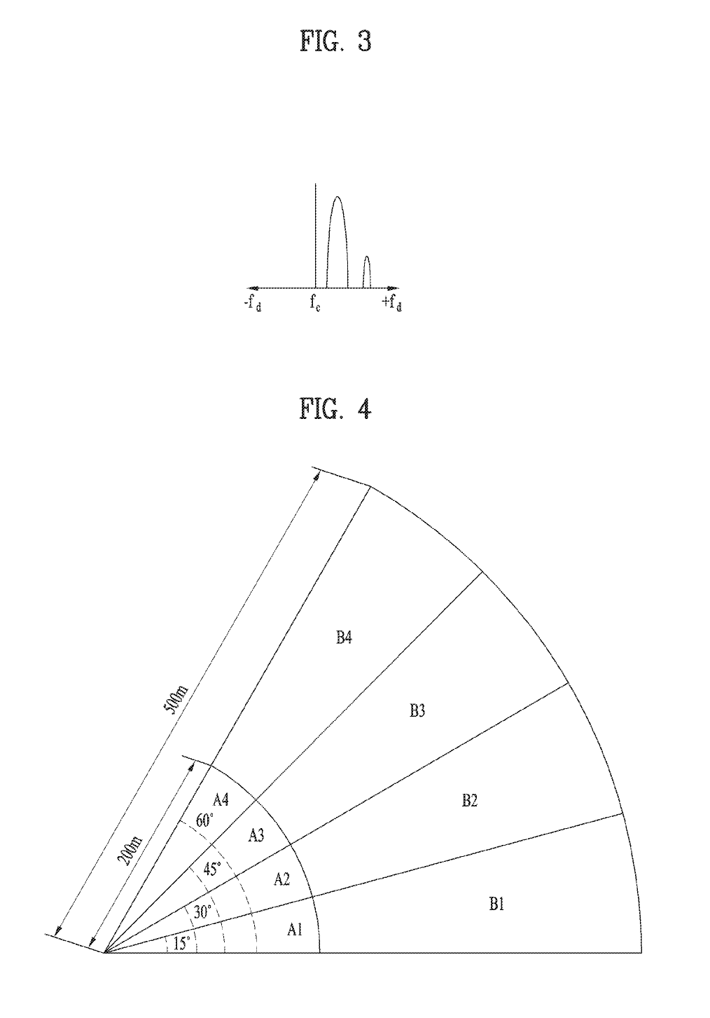

FIG. 2 is a diagram illustrating narrow beamforming related to the present invention, and FIG. 3 is a diagram illustrating a Doppler spectrum when narrow beamforming is performed.

In the ultrahigh frequency wireless communication system, since the center frequency is located at a very high band, a size of an antenna is small and an antenna array comprised of a plurality of antennas may be installed in a small space. This characteristic enables pin-point beamforming, pencil beamforming, narrow beamforming, or sharp beamforming, which is based on several tens of antennas to several hundreds of antennas. This narrow beamforming means that a received signal is received at a certain angle only not a constant direction.

FIG. 2(a) illustrates that a Doppler spectrum is represented in the form of U-shape depending on a signal received in a constant direction, and FIG. 2(b) illustrates that narrow beamforming based on a plurality of antennas is performed.

As described above, if narrow beamforming is performed, the Doppler spectrum is represented to be narrower than U-shape due to reduced angular spread. As shown in FIG. 3, it is noted from the Doppler spectrum when narrow beamforming is performed that Doppler spread is generated at a certain band only.

The aforementioned wireless communication system using the ultrahigh frequency band operates on a band having a center frequency ranging from several GHz to several tens of GHz. The characteristics of such a center frequency further worsen Doppler Effect generated from migration of a user equipment or influence of CFO due to an oscillator difference between a transmitter and a receiver.

FIG. 4 is a diagram showing an example of a synchronization signal service area of a base station.

A user equipment (hereinafter abbreviated UE) performs synchronization with a base station using a downlink (DL) synchronization signal transmitted by the base station. In such a synchronization procedure, timing and frequency are synchronized between the base station and the UE. In order to enable UEs in a specific cell to receive and use a synchronization signal in a synchronization procedure, the base station transmits the synchronization signal by configuring a beam width as wide as possible.

Meanwhile, in case of an mmWave communication system that uses a high frequency band, a path loss in synchronization signal transmission appears greater than that of a case of using a low frequency band. Namely, a system using a high frequency band has a supportable cell radius reduced more than that of a related art cellular system (e.g., LTE/LTE-A) using a relatively low frequency band (e.g., 6 GHz or less).

As a method for solving the reduction of the cell radius, a synchronization signal transmitting method using a beamforming may be used. Although a cell radius increases in case of using a beamforming, a beam width is reduced disadvantageously. Equation 2 shows variation of a received signal SINR according to a beam width.

W→M⁻²W

SINR→M²SINR [Equation 2]

If a beam width is reduced by M⁻² time according to a beamforming, Equation 2 indicates that a received SINR is improved by M² times.

Beside such a beamforming scheme, as another method for solving the cell radius reduction, it is able to consider a scheme of transmitting a same synchronization signal repeatedly. In case of such a scheme, although an addition resource allocation is necessary or a time axis, a cell radius can be advantageously increased without a decrease of a beam width.

Meanwhile, a base station allocates a resource to each UE by scheduling a frequency resource and a time resource located in a specific section. In the following, such a sp4cific section shall be defined as a sector. In the sector shown in FIG. 4, A1, A2, A3 and A4 indicate sectors having widths of 0˜15′, 15˜30′, 30˜45′ and 45˜60′ in radius of 0˜200 m, respectively. B1, B2, B3 and B4 indicate sectors having widths of 0˜15′, 15˜30′, 30˜45′ and 45˜60′ in radius of 200˜500 m, respectively. Based on the substance shown in FIG. 4, sector 1 is defined as {A1, A2, A3, A4} and sector 2 is defined as {A1, A2, A3, A4, B1, B2, B3, B4}. Moreover, if a current synchronization signal service area of a base station is the sector 1, in order for the base station to service a synchronization signal for the sector 2, assume that an additional power over 6 dB is required for a transmission of a synchronization signal.

First of all, in order to service the sector 2, the base station can obtain an additional gain of 6 dB using a beamforming scheme. Through such a beamforming process, a service radius can be extended from A1 to B1. Yet, since a beam width is reduced through the beamforming, A2 to A3 cannot be serviced simultaneously. Hence, when a beamforming is performed, a synchronization signal should be sent to each of the A2˜B2, A3˜B3, and A4˜B4 sectors separately. So to speak, in order to service the sector 2, the base station should transmit the synchronization signal by performing the beamforming four times.

On the other hand, considering the aforementioned repetitive transmission of the synchronization signal, the base station may be able to transmit the synchronization signal to the whole sector 2. Yet, the synchronization signal should transmit the synchronization signal on a time axis repeatedly four times. Consequently, a resource necessary to service the sector 2 is identical for both a beamforming scheme and a repetitive transmission scheme.

Yet, since a beam width is narrow in case of to beamforming scheme, a UE moving fast or a UE located on a sector boundary has difficulty in receiving a synchronization signal stably. Instead, if an ID of a UE located beam is identifiable, a UE can advantageously grasp its location through a synchronization signal. On the contrary, since a beam width is wide in case of a repetitive transmission scheme, it is less probable that a UE misses a synchronization signal. Instead, the UE is unable to grasp its location.

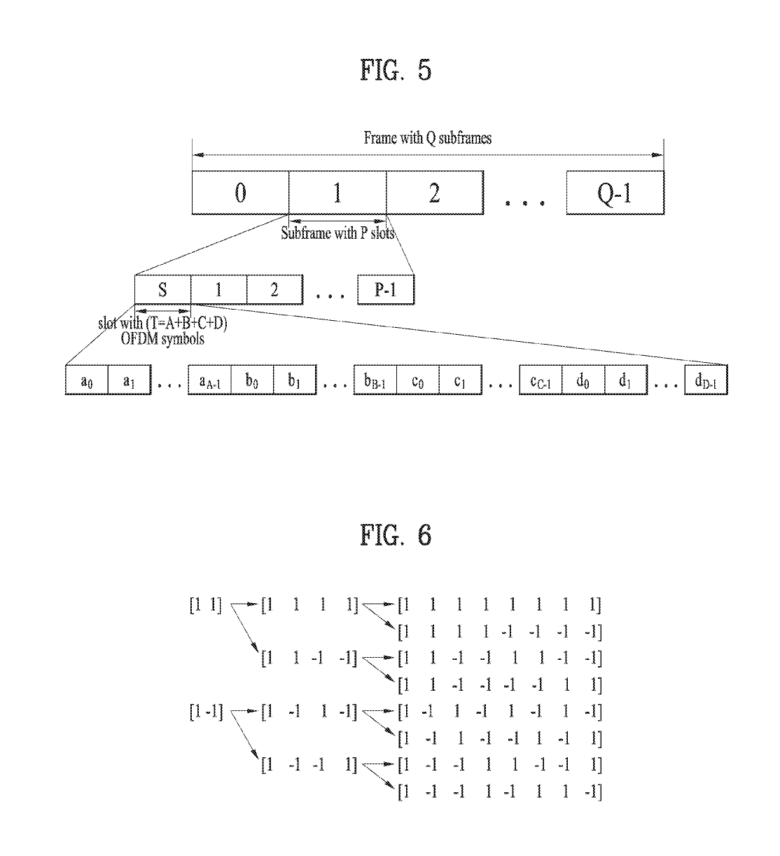

FIG. 5 shows an example of a frame structure proposed in a communication environment that uses mmWave.

First of all, a single frame is configured with Q subframes, and a single subframe is configured with P slots. And, one slot is configured with T OFDM symbols. Here, unlike other subframes, a first subframe in a frame uses 0^{th} slot (slot denoted by ‘S’) for the usage of synchronization. And, the 0^{th} slot is configured with A OFDM symbols for timing and frequency synchronization, B OFDM symbols for beam scanning, and C OFDM symbols for informing a UE of system information. And, the remaining D OFDM symbols are used for data transmission to each UE.

Meanwhile, such a frame structure is a simple example only. Q, P, T, S, A, B, C and D are random values, and may include values set by a user or values set automatically on a system.

In the following, algorithm of timing synchronization between a base station and a UE is described. Let's consider a case that the base station transmits the same synchronization signal A times in FIG. 5. Based on the synchronization signal transmitted by the base station, the UE performs timing synchronization using the algorithm of Equation 3.

$$\hat{n} = {arg max}_{\tilde{n}} \frac{\vert {\sum }_{i = 0}^{A - 2} {y}_{\tilde{n} , i}^{H} {y}_{\tilde{n} , i + 1} \vert}{{\sum }_{i = 0}^{A - 2} \vert {y}_{\tilde{n} , i}^{H} {y}_{\tilde{n} , i + 1} \vert} \\ where {y}_{\tilde{n} , i} r [ \tilde{n} + i ( N + {N}_{g} ) \text{:} \tilde{n} + i ( N + {N}_{g} ) + N - 1 ] \qquad [ Equation 3 ]$$

In Equation 3, N, N_{g} and i indicate a length of OFDM symbol, a length of CP (Cyclic Prefix) and an index of OFDM symbol, respectively. r means a vector of a received signal in a receiver. Here, the equation y_{ii,i} [symbol] r[ñ+i(N+N_{g}):ñ+i(N+N_{g})+N−1] is a vector defined with elements ranging from (ñ+i(N+N_{g}))^{th} element to (ñ+i(N+N_{g})+N−1)^{th} element of the received signal vector r.

The algorithm of Equation 3 operates on the condition that 2 OFDM received signals adjacent to each other temporally are equal to each other. Since such an algorithm can use a sliding window scheme, it can be implemented with low complexity and has a property robust to a frequency offset.

Meanwhile, Equation 4 represents an algorithm of performing timing synchronization using correlation between a received signal and a signal transmitted by a base station.

$$\hat{n} = {arg max}_{\tilde{n}} \frac{{\vert {\sum }_{i = 0}^{A - 1} {y}_{\tilde{n} , i}^{H} s \vert}^{2}}{{\sum }_{i = 0}^{A - 1} {\vert {y}_{\tilde{n} , i} \vert}^{2} {\sum }_{i = 0}^{A - 1} {\vert s \vert}^{2}} \qquad [ Equation 4 ]$$

In Equation 4, s means a signal transmitted by a base station and is a signal vector pre-agreed between a UE and a base station. Although the way of Equation 4 may have performance better than that of Equation 3, since Equation 4 cannot be implemented by a sliding window scheme, it requires high complexity. And, the way of Equation 4 has a property vulnerable to a frequency offset.

In continuation with the description of the timing synchronization scheme, a beam scanning procedure is described as follows. First of all, a beam scanning means an operation of a transmitter and/or a receiver that looks for a direction of a beam that maximizes a received SINR of the receiver. For example, a base station determines a direction of a beam through a beam scanning before transmitting data to a UE.

Further description is made by taking FIG. 4 as one example. FIG. 4 shows that a sector serviced by a single base station is divided into 8 areas. Here, the base station transmits a beam to each of (A1+B1), (A2+B2), (A3+B3) and (A4+B4) areas, and a UE can identify the beams transmitted by the base station. On this condition, a beam scanning procedure can be embodied into 4 kinds of processes. First of all, the base station transmits beams to 4 areas in sequence [i]. The UE determines a beam decided as a most appropriate beam among the beams in aspect of a received SINR [ii]. The UE feds back information on the selected beam to the base station [iii]. The base station transmits data using a beam having the direction of the feedback [iv]. Through the above beam scanning procedure, the UE can receive DL data through a beam having an optimized received SINR.

Zadoff-Chu sequence is described in the following. Zadoff-Chu sequence is called Chu sequence or ZC sequence and defined as Equation 5.

$${x}_{r} [ n ] = {e}^{\frac{j π rn ( n + 1 )}{N}} \qquad [ Equation 5 ]$$

In Equation 5, N indicates a length of sequence, r indicates a root value, and xᵣ[n] indicates an n^{th} element of ZC sequence. The ZC sequence is characterized in that all elements are equal to each other in size [constant amplitude]. Moreover, a DFT result of ZC sequence is also identical for all elements.

In the following, ZC sequence and a cyclic shifted version of the ZC sequence have the following correlation such as Equation 6.

$${( {x}_{r}^{( i )} )}^{H} {x}_{r}^{( j )} = \{ \begin{matrix}N & for i = j \\ 0 & elsewhere\end{matrix} \qquad [ Equation 6 ]$$

In Equation 6, Xᵣ⁽ⁱ⁾ is a sequence resulting from cyclic-shifting X^{r} by i, and indicates 0 except a case that auto-correlation of ZC sequence is i=j. The ZC sequence also has zero auto-correlation property and may be expressed as having CAZAC (Constant Amplitude Zero Auto Correlation) property.

Regarding the final property of the ZC sequence ZC, the correlation shown in Equation 7 is established between ZC sequences having a root value that is a coprime of a sequence length N.

$${x}_{{r}_{1}}^{H} {x}_{{r}_{2}} = \{ \begin{matrix}N & for {r}_{1} = {r}_{2} \\ \frac{1}{\sqrt{N}} & elsewhere\end{matrix} \qquad [ Equation 7 ]$$

In equation 7, r₁ or r₂ is a coprime of N. For example, if N=111, 2≤r₁, r₂≤110 always meets Equation 7. Unlike auto-correlation of Equation 6, the mutual correlation of ZC sequence does not become 0 completely.

In continuation with ZC sequence, Hadamard matrix is described. The Hadamard matrix is defined as Equation 8.

$${H}_{{2}^{k}} = [ \begin{matrix}{H}_{{2}^{k - 1}} & {H}_{{2}^{k - 1}} \\ {H}_{{2}^{k - 1}} & - {H}_{{2}^{k - 1}}\end{matrix} ] = {H}_{2} ⊗ {H}_{{2}^{k - 1}} \\ where \begin{matrix}{H}_{1} = [ 1 ] \\ {H}_{2} = [ \begin{matrix}1 & 1 \\ 1 & - 1\end{matrix} ]\end{matrix} \qquad [ Equation 8 ]$$

In Equation 8, 2^{k} indicates a size of matrix. Hadamard matrix is a unitary matrix that always meets HₙHₙ^{T}=nIₙ irrespective of a size n. Moreover, in Hadamard matrix, all columns and all rows are orthogonal to each other. For example, if n=4, Hadamard matrix is defined as Equation 9.

$${H}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] \qquad [ Equation 9 ]$$

From Equation 9, it can be observed that columns and rows are orthogonal to each other.

FIG. 6 shows a structure of OVSF (orthogonal variable spreading factor) code. The OVSF code is the code generated on the basis of Hadamard matrix and has specific rules.

First of all, in diverging to the right in the OVSF code [lower branch], a first code repeats a left mother code twice as it is and a second code is generated from repeating an upper code once, inverting it and then repeating the inverted code once. FIG. 6 shows a tree structure of OVSF code.

Such an OVSF code secures all orthogonality except the relation between adjacent mother and child codes on a code tree. For example, in FIG. 6, a code [1 −1 1 −1] is orthogonal to all of [1 1], [1 1 1 1], and [1 1 −1 −1]. Moreover, regarding the OVSF code, a length of code is equal to the number of available codes. Namely, it can be observed from FIG. 6 that a length of a specific ode is equal to the total number in a branch having the corresponding code belong thereto.

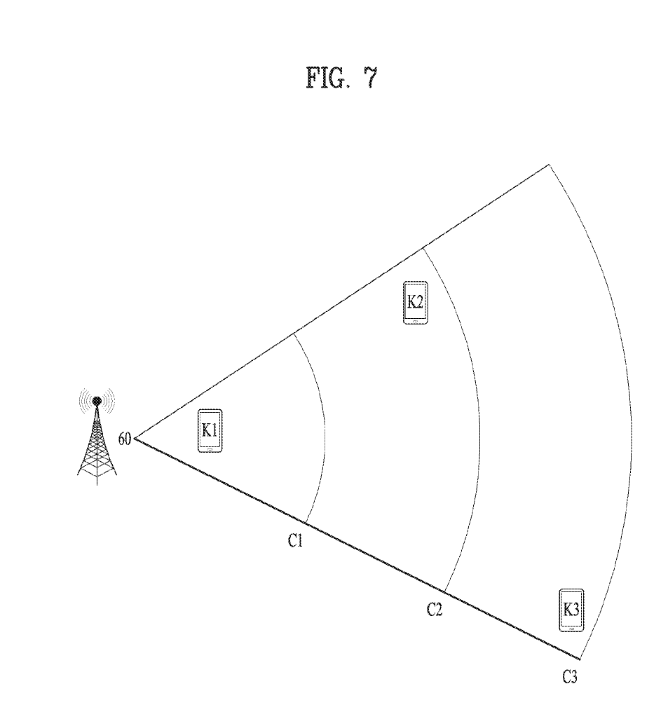

FIG. 7 is a diagram to describe a disposed situation of user equipments. RACH (Random Access CHannel) is described with reference to FIG. 7.

In case of LTE system, when RACH signals transmitted by UEs arrive at a base station, powers of the RACH signals of UEs received by the base station should be equal to each other. To this end, the base station defines a parameter ‘preambleInitialReceivedTargetPower’, thereby broadcasting the parameter to all UEs within a corresponding cell through SIB (System Information Block) 2. The UE calculates a pathloss using a reference signal, and then determines a transmit power of the RACH signal using the calculated pathloss and the parameter ‘preambleInitialReceivedTargetPower’ like Equation 10.

P_PRACH_Initial=min {P_CMAX, preambleInitialReceivedTargetPower+PL} [Equation 10]

In Equation 10, P_PRACH_Initial, P_CMAX, and PL indicate a transmit power of RACH signal, a maximum transmit power of UE, and a pathloss, respectively.

Equation 10 is taken as one example for the following description. A maximum transmittable power of UE is assumed as 23 dBm, and a RACH reception power of a base station is assumed as −104 dBm. And, a UE disposed situation is assumed as FIG. 7.

First of all, a UE calculates a pathloss using a received synchronization signal and a beam scanning signal and then determines a transmit power based on the calculation. Table 3 shows a pathloss of UE and a corresponding transmit power.

TABLE 3

| | preambleInitialRe- | | | Necessary | | | | Additional |
|---|---|---|---|---|---|---|---|---|
| UE | ceivedTargetPower | Pathloss | | transmit power | | Transmit power | | necessary power |
| K1 | −104 dBm | 60 | dB | −44 | dBm | −44 | dBm | 0 dBm |
| K2 | −104 dBm | 110 | dB | 6 | dBm | 6 | dBm | 0 dBm |
| K3 | −104 dBm | 130 | dB | 26 | dBm | 23 | dBm | 3 dBm |

In case of a UE K1 in table 3, a pathloss is very small. Yet, in order to match an RACH reception power, an RACH signal should be transmitted with very small power (−44 dBm). Meanwhile, in case of a UE K2, although a pathloss is big, a necessary transmit power is 6 dBm. Yet, in case of a UE K3, since a pathloss is very big, a necessary transmit power exceeds P_CMA=23 dBm. In this case, the UE should perform a transmission with 23 dBm that is a maximum transmit power and a rate of UE's RACH access success is degraded by 3 dB.

In the following, phase noise related to the present invention is explained. Jitter generated on a time axis appears as phase noise on a frequency axis. As shown in equation 11 in the following, the phase noise randomly changes a phase of a reception signal on the time axis.

$${r}_{n} = {s}_{n} {e}^{j {φ}_{n}} \\ where {s}_{n} = {\sum }_{k = 0}^{N - 1} {d}_{k} {e}^{j 2 π \frac{kn}{N}} \qquad [ Equation 11 ]$$

Parameters of the equation 11 respectively indicate a reception signal, a time axis signal, a frequency axis signal, and a phase rotation value due to the phase noise. In the equation 11, if the reception signal is passing through a DFT (Discrete Fourier Transform) procedure, it may be able to have equation 12 described in the following.

$${y}_{k} = {d}_{k} \frac{1}{N} {\sum }_{n = 0}^{N - 1} {e}^{j {φ}_{n}} + \frac{1}{N} {\sum }_{{t = 0}_{t \neq k}}^{N - 1} {d}_{t} {\sum }_{n = 0}^{N - 1} {e}^{j {φ}_{n}} {e}^{j 2 π ( t - k ) m \text{/} N} \qquad [ Equation 12 ]$$

In the equation 12,

$$\frac{1}{N} {\sum }_{n = 0}^{N - 1} {e}^{j {φ}_{n}} , \frac{1}{N} {\sum }_{{t = 0}_{t \neq k}}^{N - 1} {d}_{t} {\sum }_{n = 0}^{N - 1} {e}^{j {φ}_{n}} {e}^{j 2 π ( t - k ) m \text{/} N}$$

indicate a CPE (common phase error) and ICI (inter-cell interference), respectively. In this case, as correlation between phase noises is getting bigger, the CPE of the equation 12 has a bigger value. The CPE is a sort of CFO (carrier frequency offset) in a wireless LAN system. However, since the CPE corresponds to phase noise in the aspect of a terminal, the CPE and the CFO can be similarly comprehended.

A terminal eliminates the CPE/CFO corresponding to phase noise on a frequency axis by estimating the CPE/CFO. A procedure of estimating the CPE/CFO on a reception signal should be preferentially performed by the terminal to accurately decode the reception signal. In particular, in order to make the terminal precisely estimate the CPE/CFO, a base station can transmit a prescribed signal to the terminal. The signal transmitted by the base station corresponds to a signal for eliminating phase noise. The signal may correspond to a pilot signal shred between the terminal and the base station in advance or a signal changed or copied from a data signal. In the following a signal for eliminating phase noise is commonly referred to as a PCRS (Phase Compensation Reference Signal), or a PNRS (Phase Noise Reference Signal).

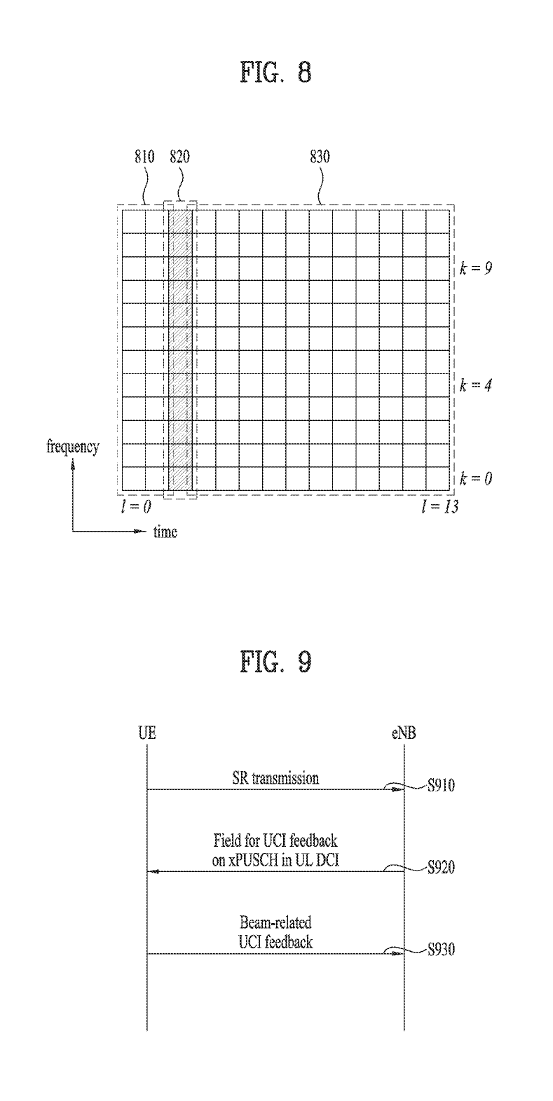

FIG. 8 is a diagram illustrating a resource region structure used in a communication system using mmWave. A communication system using such a ultrahigh frequency band as mmWave uses a frequency band having physical characteristic different from that of a legacy LTE/LTE-A communication system. Hence, it is necessary for the communication system using the ultrahigh frequency band to use a structure of a resource region different from a structure of a resource region used in a legacy communication system. FIG. 8 illustrates an example of a downlink resource structure of a new communication system.

It may consider an RB pair consisting of 14 OFDM (Orthogonal Frequency Division Multiplexing) symbols in a horizontal axis and 12 subcarriers in a vertical axis. In this case, first 2 (or 3) OFDM symbols 810 are allocated for a control channel (e.g., PDCCH (Physical Downlink Control Channel)), a next one OFDM symbol 820 is allocated for a DMRS (DeModulation Reference Signal), and the remaining OFDM symbols 830 are allocated for a data channel (e.g., PDSCH (Physical Downlink Shared Channel)).

Meanwhile, in the resource region structure shown in FIG. 8, a PCRS for estimating the aforementioned CPE (or, the CFO), or a PNRS can be transmitted to a terminal in a manner of being carried on a partial RE (resource element) of the region 830 to which a data channel is assigned. The signals correspond to a signal for eliminating phase noise. As mentioned in the foregoing description, the signal may correspond to a pilot signal or a signal changed or copied from a data signal.

2. Proposed Method for Transmitting Information

As mentioned in the foregoing description, beamforming performed by a base station on a user equipment is important in a communication system using mmWave band. This is because, if more high frequency bands are used, a pathloss is getting worse. In particular, when a user equipment determines that a beam mismatch is serious based on a signal received from a base station, the user equipment should transmit a signal for solving the beam mismatch to the base station.

In the following, an embodiment for a user equipment to transmit beamforming-related information to a base station is proposed. As mentioned in the foregoing description, the beamforming-related information transmitted to the base station by the user equipment can be referred to as BSI (Beam State Information), BRI (Beam Related Information), or beam related (uplink) control information. If the user equipment determines that a level of a beam mismatch is high, the user equipment can transmit the BSI to the base station. The beamforming-related information can include information on a beam currently beamformed to the user equipment including information on a beam index, information on beam reception power, and the like. In particular, the beamforming-related information can include index information of a beam preferred by the user equipment. Hence, if the user equipment transmits the beamforming-related information to the base station, the base station is able to recognize that a level of a beam mismatch is high between the user equipment and the base station.

Meanwhile, in order for a user equipment to transmit beamforming-related information to a base station, the user equipment should preferentially receive an uplink grant or uplink assignment. In particular, in order for the user equipment to transmit the beamforming-related information to the base station, it is necessary to preferentially perform a procedure indicating that it is necessary for the user equipment to have an uplink grant or uplink assignment (hereinafter, for clarity, UL grant) to enable the user equipment to transmit the beamforming-related information to the base station.

Hence, the user equipment can transmit a signal for requesting a UL grant to the base station to transmit the beamforming-related information. The signal for requesting the UL grant may correspond to an SR (Scheduling Request).

The present invention proposes a method of allocating a resource in which an SR is transmitted according to a purpose of the SR. In particular, according to the present invention, a plurality of SR resources different from each other can be allocated to a UE based on a purpose of an SR.

A method of transmitting a signal is explained in more detail with referent to FIG. 9. FIG. 9 is a flowchart illustrating a method of transmitting a signal according to a proposed embodiment.

According to a related art, a single SR resource is allocated to a UE and the UE transmits an SR for requesting an UL grant using the single SR resource. In this case, the SR basically corresponds to a signal requested by a UE to transmit data. In particular, unlike the proposal proposed by the present invention, it is unable to utilize the SR as a means for solving a beam mismatch. Moreover, since a single SR resource is allocated to the UE only, if the UE requests a UL grant using the single SR resource, a base station is unable to distinguish a case that the UE simply transmits an SR to transmit uplink data from a case that the UE transmits an SR to transmit beamforming-related information. In particular, since the base station is unable to determine a reason for transmitting an SR transmitted by the UE, an ambiguity problem occurs. In particular, according to the related art, when the UE transmits an SR to the base station to transmit beamforming-related information, the base station may simply recognize the SR as a request for transmitting data. As a result, the base station can transmit a UL grant to the UE to simply request data transmission. In this case, although the UE transmits UCI to the base station, since it is likely that the base station does not assume transmission of the UCI, the base station may fail to properly decode a signal (e.g., beamforming-related information) transmitted by the UE.

Unlike the related art, the present invention proposes a method of allocating a plurality of SR resources to a UE based on a purpose of an SR.

A plurality of the SR resources can include 2 SR resources or 3 SR resources depending on an embodiment.

First of all, a plurality of the SR resources can include a first SR resource used for transmitting a normal PUSCH (or xPUSCH). In other word, a plurality of the SR resource can include the first SR resource for transmitting an SR that requests an uplink resource for transmitting uplink data transmitted by a UE.

And, as mentioned in the foregoing description, a plurality of the SR resources can include a second SR resource for requesting a UL grant which is used for a UE to transmit beamforming-related information.

In addition, a plurality of the SR resources can include a third SR resource for requesting a BRRS (beam refinement reference signal) transmitted by a base station.

In this case, the 2 SR resources (first/second SR resource) or the 3 SR resources have an alternative relationship. In particular, the 2 SR resources or the 3 SR resources can be configured by resources different from each other.

When resources are different from each other, it means that at least one of a sequence and a time/frequency resource is different.

The aforementioned first SR resource corresponds to a resource for transmitting a general uplink data channel and can be defined to be identical to an SR resource defined in a legacy LTE system.

The aforementioned second SR resource corresponds to an additional resource newly allocated to a UE by a base station to solve a beam mismatch between the base station and the UE. The second SR resource can be distinguished from the first SR resource.

The aforementioned third SR resource corresponds to a resource for requesting transmission of a BRRS corresponding to a reference signal used for a procedure of selecting a beam preferred by a UE. Unless there is a beam preferred by a UE, the UE asks the base station to transmit a plurality of beams to select a beam preferred by the UE. Or, the UE asks the base station to transmit a plurality of beams to correct a beam received by the UE. To this end, the third SR resource transmits an SR to the base station to ask the base station to transmit a plurality of beams.

In some cases, the BRRS may not be defined. If the BRRS is not defined in advance, the third SR resource may not be allocated to the UE.

The base station can allocate a plurality of SR resources to the UE in various ways. For example, when the UE is in an RRC (radio resource control) connected state, the base station can allocate a plurality of the SR resources to the UE via UE-specific RRC signaling or DCI (downlink control information) signaling.

Subsequently, according to the present invention, when the UE determines that it is necessary for the UE to transmit beam-related information (e.g., BSI) to the base station due to the occurrence of a beam mismatch, the UE transmits an SR to the base station via the second SR resource [S910]. The SR can be interpreted as a signal for requesting a UL grant to the base station to transmit beam-related information.

Having received the SR from the UE via the second SR resource, the base station determines that a beam mismatch has occurred at the UE. The base station defines a UL feedback request field (or xPUSCH UCI feedback request field), configures a value of the field by 0 or 1, and transmits downlink control information to the UE [S920]. In this case, the UL feedback request field (or xPUSCH UCI feedback request field) may correspond to a procedure that the base station asks the UE to transmit UCI including beam-related information by multiplexing the UCI. The UL feedback request field (or xPUSCH UCI feedback request field) can be transmitted to the UE periodically or aperiodically. In this case, the downlink control information can be transmitted via xPDCCH (x-Physical Downlink Control Channel).

As mentioned in the foregoing description, a field for allowing uplink control information multiplexing is defined in the UL grant transmitted by the base station and the field can be referred to as a UL feedback request field. When the base station allows the UE to transmit uplink control information (e.g., beam-related information) by multiplexing the uplink control information (i.e., piggyback), a value of the UL feedback request field is enabled by ‘1’. When the base station does not allow the UE to transmit uplink control information (e.g., beam-related information), a value of the UL feedback request field is disabled by ‘0’. The value of the UL feedback request field configured by ‘1’ and ‘0’ is just an example only. The value of the field can be inversely configured or can be configured by a different value. In particular, the value of the field can be configured by a bit value for allowing or not allowing the UE to perform a procedure of multiplexing and transmitting control information.

Subsequently, the UE checks a value of the UL feedback request field (or xPUSCH UCI feedback request field). If the UE is allowed to perform multiplexing on beam-related information and transmit the multiplexed beam-related information (i.e., if a UL grant is received), the UE transmits the beam-related information to the base station by multiplexing the information with xPUSCH [S930]. Of course, if a value of the field received in the step S920 is not a value for requesting the beam-related information, the UE does not transmit the beam-related information to the base station. In this case, the beam-related information may indicate the base station to adjust beamforming (e.g., beam direction or beam width) or perform beamforming again due to a high level of mismatch.

Having received the beam-related information via the abovementioned steps, the base station is able to know information on a beam (e.g., beam index) preferred by the UE. The base station can perform a service on the UE using a transmission beam corresponding to the information. In other word, the base station solves a beam mismatch problem using the information on the beam preferred by the UE obtained by the aforementioned steps. When the base station provides a service to the UE, the base statin may use the beam preferred by the UE.

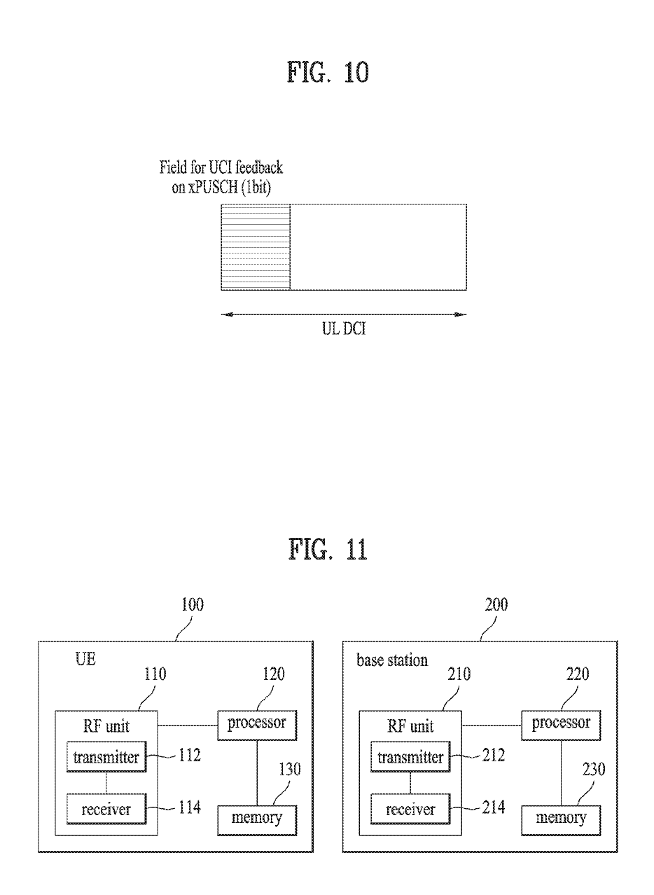

FIG. 10 is a diagram illustrating a method of configuring a field according to a different proposed embodiment. FIG. 10 illustrates an example of configuring the aforementioned UL feedback request field (or xPUSCH UCI feedback request field) of the base station.

A specific UE transmits a first SR to a base station. Having received the first SR, the base station determines a value of a specific field included in a UL grant of xPDCCH (UL DCI) to be transmitted to the UE by 1. In particular, when the specific UE firstly asks the base station to transmit beam-related information, the base station can transmit a UL grant for transmitting the beam-related information to the UE. As mentioned in the foregoing description, the field can be configured by 1 bit. Although FIG. 10 illustrates a case that the field is implemented by the very first bit of UL DCI, by which the present invention may be non-limited. The field can be implemented by a middle bit or the last bit of the UL DCI. If a value of the bit corresponds to ‘1’, it indicates that multiplexing and transmission of the beam-related information are requested (i.e., allowed). If the value of the bit corresponds to ‘0’, it indicates that multiplexing and transmission of the beam-related information are not requested (i.e., not allowed). Of course, meaning of the bit value can be inversely configured.

Among the aforementioned SR resources, it is necessary to define an additional resource for the first and the third SR resources compared to the second SR resource. On the other hand, an operation of implicitly determining a value of a UL feedback request field (or xPUSCH UCI feedback request field) determined by a base station or a UE without additional resource allocation is proposed in the following.

According to one embodiment, when a base station receives an SR transmitted by a UE using the first SR resource, the base station determines a value of a UL feedback request field (or xPUSCH UCI feedback request field) by ‘1’ when a specific condition is satisfied. The specific condition can be defined by a time interval between the SR received by the base station and a previously received SR. In particular, if a subframe (or frame) gap between the SR received by the base station and an SR previously received from the same UE is equal to or greater than a predetermined number (N), although there is no UL grant request received from the UE using the second SR resource, the base station can determine a value of the UL feedback request field (or xPUSCH UCI feedback request field) by ‘1’ to make the UE transmit BSI. The method above can be performed under the assumption that a beam between the UE and the base station is not considerably changed during a predetermined time period. According to the method, it is able to minimize unnecessary UCI feedback. In communication environment in which a beam is rapidly changing, a value of N corresponding to the number of subframes should be configured by a smaller value. On the other hand, in communication environment in which a beam is slowly changing, the value of N should be configured by a bigger value.

According to a different embodiment, when the UE firstly receives a UL feedback request field (or xPUSCH UCI feedback request field) after an SR is transmitted, the UE may assume that a value of the UL feedback request field corresponds to ‘1’. In particular, although a value of the UL feedback request field (or xPUSCH UCI feedback request field) is not defined in a UL grant firstly received from the base station, the UE can transmit UCI including beam-related information to the base station by multiplexing the UCI.

Moreover, if a specific condition is satisfied after an SR is transmitted, the UE may assume that the value of the UL feedback request field (or xPUSCH UCI feedback request field) corresponds to ‘1’. Similar to the description on the base station, when an SR is transmitted after the predetermined number of subframes (or frames) appearing after an SR transmitted to the base station by the UE, although a value of the UL feedback request field (or xPUSCH UCI feedback request field) is not additionally defined in a UL grant received from the base station, the UE can transmit BSI to the base station.

According to the aforementioned embodiments, the UE can ask the base station to perform uplink scheduling to transmit beam-related information to the base station according to a beam mismatch. If the UE receives a UL grant from the base station, the UE can transmit the beam-related information to the base station.

3. Device Configuration

FIG. 11 is a block diagram showing the configuration of a user equipment and a base station according to one embodiment of the present invention. In FIG. 11, the user equipment 100 and the base station 200 may include radio frequency (RF) units 110 and 210, processors 120 and 220 and memories 130 and 230, respectively. Although a 1:1 communication environment between the user equipment 100 and the base station 200 is shown in FIG. 11, a communication environment may be established between a plurality of user equipment and the base station. In addition, the base station 200 shown in FIG. 11 is applicable to a macro cell base station and a small cell base station.

The RF units 110 and 210 may include transmitters 112 and 212 and receivers 114 and 214, respectively. The transmitter 112 and the receiver 114 of the user equipment 100 are configured to transmit and receive signals to and from the base station 200 and other user equipments and the processor 120 is functionally connected to the transmitter 112 and the receiver 114 to control a process of, at the transmitter 112 and the receiver 114, transmitting and receiving signals to and from other devices. The processor 120 processes a signal to be transmitted, sends the processed signal to the transmitter 112 and processes a signal received by the receiver 114.

If necessary, the processor 120 may store information included in an exchanged message in the memory 130. By this structure, the user equipment 100 may perform the methods of the various embodiments of the present invention.

The transmitter 212 and the receiver 214 of the base station 200 are configured to transmit and receive signals to and from another base station and user equipments and the processor 220 are functionally connected to the transmitter 212 and the receiver 214 to control a process of, at the transmitter 212 and the receiver 214, transmitting and receiving signals to and from other devices. The processor 220 processes a signal to be transmitted, sends the processed signal to the transmitter 212 and processes a signal received by the receiver 214. If necessary, the processor 220 may store information included in an exchanged message in the memory 230. By this structure, the base station 200 may perform the methods of the various embodiments of the present invention.

The processors 120 and 220 of the user equipment 100 and the base station 200 instruct (for example, control, adjust, or manage) the operations of the user equipment 100 and the base station 200, respectively. The processors 120 and 220 may be connected to the memories 130 and 230 for storing program code and data, respectively. The memories 130 and 230 are respectively connected to the processors 120 and 220 so as to store operating systems, applications and general files.

The processors 120 and 220 of the present invention may be called controllers, microcontrollers, microprocessors, microcomputers, etc. The processors 120 and 220 may be implemented by hardware, firmware, software, or a combination thereof.

If the embodiments of the present invention are implemented by hardware, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), etc. may be included in the processors 120 and 220.

Meanwhile, the aforementioned method may be implemented as programs executable in computers and executed in general computers that operate the programs using computer readable media. In addition, data used in the aforementioned method may be recorded in computer readable recording media through various means. It should be understood that program storage devices that can be used to describe storage devices including computer code executable to perform various methods of the present invention do not include temporary objects such as carrier waves or signals. The computer readable media include storage media such as magnetic recording media (e.g. ROM, floppy disk and hard disk) and optical reading media (e.g. CD-ROM and DVD).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The aforementioned contents can be applied not only to 3GPP system and LTE-A but also to various wireless communication systems including an IEEE 802.16x system and IEEE 802.11x system. Further, the proposed method can also be applied to an mmWave communication system using ultrahigh frequency band.

What is claimed is:

1. A method of transmitting beam-related uplink control information by a user equipment (UE) in an mmWave communication system, the method comprising:
determining occurrence of a beam mismatch from a base station;
when the beam mismatch occurs, transmitting an scheduling request (SR) requesting an uplink resource for performing feedback on beam-related control information to the base station via a first resource among a plurality of resources allocated by the base station to transmit the SR;
receiving downlink control information containing uplink assignment information for performing feedback on the beam-related control information from the base station; and
transmitting uplink control information containing the beam-related control information via an uplink resource allocated by the base station,
wherein a plurality of the resources contain the first resource and a second resource in which an SR requesting an uplink resource for transmitting uplink data transmitted by the UE is transmitted and wherein the first resource is different from the second resource.

2. The method of claim 1, wherein the beam-related control information contains index information of a beam preferred by the UE.

3. The method of claim 1, wherein the uplink control information transmitting step transmits the uplink control information by multiplexing the uplink control information with a transmission region of an uplink data channel.

4. The method of claim 1, wherein the uplink assignment information for performing feedback on the beam-related control information contains a beam-related control information feedback request field having a size of 1 bit.

5. The method of claim 1, wherein when the SR corresponds to a first SR transmitted to the base station, the UE transmits the beam-related control information to the base station irrespective of a value of a beam-related control information feedback request field.

6. The method of claim 1, wherein when the SR is transmitted after the predetermined number of subframes appearing after an SR recently transmitted to the base station, the UE transmits the beam-related control information to the base station irrespective of a value of a beam-related control information feedback request field.

7. The method of claim 1, wherein a plurality of the resources further contain a third resource in which an SR requesting transmission of a beam refinement reference signal (BRRS) to the base station is transmitted and wherein the third resource is different from the first resource and the second resource.

8. The method of claim 7, when the beam mismatch occurs and there is no beam preferred by the UE, further comprising the step of transmitting the SR requesting the transmission of the BRRS to the base station via the second resource among a plurality of the resources.

9. A user equipment (UE) for transmitting uplink control information in an mmWave communication system, the UE comprising:
a transmitter;
a receiver; and
a processor connected to the transmitter and the receiver to operate,
wherein the processor is configured to:
determine occurrence of a beam mismatch from a base station;
when the beam mismatch occurs, transmit an scheduling request (SR) requesting an uplink resource for performing feedback on beam-related control information to the base station via a first resource among a plurality of resources allocated by the base station to transmit the SR;
receive downlink control information containing uplink assignment information for performing feedback on the beam-related control information from the base station; and
transmit uplink control information containing the beam-related control information via an uplink resource allocated by the base station,
wherein a plurality of the resources contain the first resource and a second resource in which an SR requesting an uplink resource for transmitting uplink data transmitted by the UE is transmitted and wherein the first resource is different from the second resource.

10. The UE of claim 9, wherein the beam-related control information contains index information of a beam preferred by the UE.

11. The UE of claim 9, wherein the processor is configured to transmit the uplink control information by multiplexing the uplink control information with a transmission region of an uplink data channel.

12. The UE of claim 9, wherein the uplink assignment information for performing feedback on the beam-related control information contains a beam-related control information feedback request field having a size of 1 bit.

13. The UE of claim 9, wherein when the SR corresponds to a first SR transmitted to the base station, the processor is configured to transmit the beam-related control information to the base station irrespective of a value of a beam-related control information feedback request field.

14. The UE of claim 9, wherein when the SR is transmitted after the predetermined number of subframes appearing after an SR recently transmitted to the base station, the processor is configured to transmit the beam-related control information to the base station irrespective of a value of a beam-related control information feedback request field.

15. The UE of claim 9, wherein a plurality of the resources further contain a third resource in which an SR requesting transmission of a beam refinement reference signa (BRRS1) to the base station is transmitted and wherein the third resource is different from the first resource and the second resource.

16. The UE of claim 15, when the beam mismatch occurs and there is no beam preferred by the UE, the processor is configured to transmit the SR requesting the transmission of the BRRS to the base station via the second resource among a plurality of the resources.
